(19) United States
(12) Patent Application Publication
(10) Pub. No.: US 2017/0299492 A1
(43) Pub. Date: Oct. 19, 2017

(54) METHOD, DEVICE AND SYSTEM FOR HYDRODYNAMIC FLOW FOCUSING

(71) Applicant: Foss Analytical A/S, Hilleroed (DK)

(72) Inventors: Lars Henning RINDORF, Fredensborg (DK); Jesper GLUCKSTAD, Frederiksberg (DK); Thomas AABO, Frederlksberg (DK)

(73) Assignee: Foss Analytical A/S, Hilleroed (DK)

(21) Appl. No.: 15/511,862

(22) PCT Filed: Sep. 30, 2015
(86) PCT No.: PCT/EP2015/072545

§ 371 Date: Mar. 16, 2017

(30) Foreign Application Priority Data
Sep. 30, 2014 (EP) 14187095.6

(51) Int. Cl. G01N 15/14; B01L 3/00; G01N 15/00; G01N 15/10

(52) U.S. Cl. CPC G01N 15/1404; B01L 3/502761; B01L 3/502776; G01N 15/1484; B01L 3/502746; B01L 2400/082; B01L 2300/0654; B01L 2200/0652; B01L 2200/0636; G01N 2015/0065; G01N 2015/1006; G01N 2015/1413; G01N 2015/149; B01L 2300/0864

(57) ABSTRACT

In a method for hydrodynamic focusing of a laminar and planar sample fluid flow, a system is provided for analysis and/or sorting of microscopic objects in the sample fluid comprising an optical objective for optical inspection of the microscopic objects. Microscopic objects are conveyed in the laminar flow of the sample fluid, and two laminar and planar flow of sheath fluids are provided. The flow of the sample fluid is hydrodynamically focused at an optical inspection zone of the system by the sheath fluids. Focusing of the flow of the sample fluid is controlled such that all of the microscopic objects in the sample fluid are caused to be conveyed in a common flow direction in one single plane at the inspection zone of the system, and the microscopic objects in the fluid are optically inspected through the optical objective.

### CROSS-REFERENCE TO RELATED APPLICATIONS

This application is the U.S. National Phase application of PCT Application No. PCT/EP2015/072545 filed on Sep. 30, 2015, which claims priority to European Patent Application No. 14187095.6 filed on Sep. 30, 2014 the entire contents of each of which are incorporated herein by reference.

### FIELD OF THE INVENTION

The present invention relates to the field of flow cytometry. Specifically, it relates to the field of hydrodynamic flow focusing and to the structure of a flow cell (referred to as a hydrodynamic flow focusing devices) and its use in optical analysis or optical laser sorting of biological cells and microparticles (referred to as microscopic objects). The flow cell may be embodied as a microfluidic flow cell.

### BACKGROUND OF THE INVENTION

### Introduction

In biotechnology, clinical diagnostics, and research there is a need to study and sort biological cells on an individual basis and this can be done with instruments capable of flow cytometry and cell sorting. Flow cytometry is a tool in cytometry, the analyses of cells and bacteria. It is a statistical tool that uses a high number of events, individual cell measurements, to deduce information about cell functions, affinities, populations etc. Thus a high throughput (speed) is necessary to measure a statistically significant number of events. Throughput is typically 50,000 cells/sec, corresponding to 100 mio. cells/hour. In comparison, 1 ml of blood contains 5 million cells.

The procedure of flow cytometry is to focus the sample suspension using a sheath liquid. A thin string of sample suspension of cells is then formed and directed through the path of an optical excitation source and an optical detector. Selective fluorescent markers are used to characterize cells according to their size, type, chemical functions, etc. The flow cytometry and cell sorting instruments are not restricted to microparticles of interest in Cytology, such as platelets, white blood cells, red blood cells, embryonic cells, tumorous cells, protein production cells, and other types of biological cells, but may also be applied to the analysis and sorting of other microparticles such as bacteria, algae, vesicles, large molecules such as proteins, and non-biological particles. We will generally refer to the all above mentioned types as ‘microparticles’ in the following.

Purposes of the sample string may be 1. To maintain the cell in the focus of the light collection optics and/or light excitation. 2. To avoid that two cells are exposed in one single event, commonly referred to as doublets. 3. To ascertain that all cells have the same velocity and thus receives the same amount of light exposure. This assures a low coefficient of variation.

The method and apparatus of microparticle sorting, such as Fluorescence Activated Cell Sorting (FACS), and flow cytometry are known and described in prior art. A central component is the flow cell which focuses the suspended microparticles to a single file in the flowing medium. Ideally, only a single microparticle is in the region of optical analysis at any given time. An additional task is that all microparticles are tightly focused to pass the confined area of optical inspection. Additionally, the microparticles should travel with identical velocity such that the laser optical exposure and the resulting signal is qualitatively identical for all cells, and such that as to avoid coincidental events when two cells passes each other in area of optical inspection giving erroneous read outs. Commonly, these targets are realized by ejecting the microparticles, sample, from a circular nozzle inserted larger coaxial circular glass tube containing a sheath flow. By adjusting the flow rates of the sheath flow and the sample flow the cells can be made to travel in a single file with high precision, until 50 nm, and with uniform velocity.

Commercially known microparticle sorters implement the focus-detect-decide-deflect operation cycle where a microparticle is first focused in a fluid medium to a path crossing an optical inspection (detect), depending on the electronic signal (decide) the microparticle is deflected to two or more reservoirs. A flow cytometer can be said to implement only the focus-detect subset operation of the microparticle sorter.

In the optical inspection there is a trade off between light collection efficiency and the depth of focus of the optical system. This is generally determined by the numerical aperture (NA) of the optical microscope objective.

Flow cytometry does in general not confer imaging capabilities. Rather the combined signal is recorded using a photo multiplier tube (PMT). For imaging, one is constrained by the fundamental laws of physics that applies to microscopes. These dictate that the resolution is given by

Res=1.22λ/(2*NA)

Where λ is the wavelength of light and NA is the numerical aperture of the light collection objective or lens. The resolution determines the size of the features which can be resolved with a given optical setup and is thus very important when imaging cells with a diameter of 2-20 microns and bacteria with a diameter of 0.5-3 microns. The depth of focus is also limited.

Δz=λ/(2*NA²)

Just like the resolution determines the size of the smallest detectable features, the depth of focus determines the maximal distance any given object can deviate from the focal plane of the optics. The field of view is given by

FOV=FN/M

Where FN is a parameter determined by the optics and M is the magnification of the objective.

As an example, a resolution of 2 microns only necessitates a more modest NA =0.125, which leads to a depth of focus Δz=16 microns using the equations above.

As another example a resolution of 0.5 micron at a wavelength λ=500 nm necessitates NA=0.5. This leads to shallow depth of focus Δz=1.0 micron using the equations above. As another example a resolution of 0.25 micron at a wavelength λ=500 nm necessitates NA=1. This leads to shallow depth of focus Δz=0.25 micron using the equations above.

The field of view at NA can easily be 400 microns. Thus the aspect of the depth of focus and transverse FOV is 1:1600 (0.25 micron:400 microns). In the remaining, FOV will be taken to incorporate also depth of focus so FOV becomes a 3 dimensional parameter.

Additionally, it should be noted that the light collection efficiency, ˜NA², is higher for higher NA.

Throughput of a flow cytometer is given by

cross section of sample string×V_{string}×particles concentration.

where ‘the cross section of sample string’ is perpendicular to the direction of flow, and V_{string} is the velocity with which sample string travels relative to the optical detector.

The fundamental facts above set some physical constraints for the performance of the flow cytometer if imaging is used. Combining this with the observation that the photon detection limit is much better for the PMT or photodiode (or other single point detector) than for imaging devices, such as CCD, CMOS, since the photons in the imaging devices are distributed onto a number of single detectors, pixels. To compensate for this intrinsic lower sensitivity of the imaging devices a lower sample string velocity has to be used. The throughput becomes unsatisfactory.

The depth of field of the objective, e.g. for NA =0.5 limits to a sample string circular in cross section and about 1 micron in diameter. The width of the field of view may be 400 microns, leaving 399 micron unused. Thus if the sample string cross section can be made 1 micron deep and 400 microns wide a high throughput can be obtain. So if a flow cell can be designed to form a flat sample string perpendicular to the optical plane a factor of 400 in throughput of the imaging flow cytometer. In the last decades, miniaturized analysis systems have received much attention, with a promise for cheaper, out of core-laboratory, for chemical and biological analysis, as well running complete laboratory routines automated on-chip. Multiple advantages can be gained by shifting to the microfluid lab-on-chip approach. However, compared with the established instruments the microfluidic systems have so far only offered limited analysis and sorting capabilities. The main obstacle has been the fact that the design of the flow cell of the established instruments is not readily transferable into the microfluidic flow cell fabrication technology. In microfluidic systems it is difficult to fabricate a circular nozzle inside a coaxial tube.

Microfluidic chips are typically fabricated in one or more substrates. The substrate has grooves and structures which become channels, chambers, and networks of these when assembled. The material of the substrate is typically polymers, silicon, or other and may be fabricated by casting, injection moulding, micromilling, photolithography and etching etc. After processing the substrates are stacked and bonded to form the microfluidic chip.

In the stacked substrates it is well known how to realize a flow cell with 1 dimensional (1 D) sheath flow where a sample flow is hydrodynamically focused in a direction oriented in the substrate plane. Due to the built up construction of substrates a microfluidic system 2D hydrodynamic focusing is much more challenging.

### Wolff 2003

An example of 2D hydrodynamic focusing and sorting on a microfluidic flow cell was demonstrated by Wolff and co-workers (1). They realized a channel in the microfluidic system with a sample nozzle protruding into the channel. They demonstrated focusing of the microparticles to a file. They call the design a ‘smoking chimney’. The orientations of the nozzle and the channel were perpendicular, and the channel was rectangular in cross section and the nozzle circular. In common practice, the channel and nozzle are coaxially orientated and both circular in cross section. They used a valve to control the outlet flow and to sort the cells by hydrodynamic sorting. Although an intuitive and seemingly sound design, it was quite demanding in fabrication requiring clean room processing of silicon substrates with tight tolerances. The design with sharp angles is susceptible to sedimentation of microparticles fouling the microfluidic system as well as blow down of the sample fluid. Due the protruding nozzle in the center of the larger channel the design is also susceptible to catching air bubbles which will be stuck on the front side of the nozzle. Occurrence of air bubbles is a common source of fouling of microfluidic systems. Microfluidic systems, which are susceptible to fouling by air bubbles, are not robust in large-scale use beyond the prototypes.

### Yang 2005

An example of a 2D flow focusing microfluidic system was demonstrated by Yang and co-workers (2). The microfluidic system focuses the microparticles to a file and does not suffer from the ‘blow down’ effect and high susceptibility of air bubble fouling. The complexity of manufacturing is significantly increased since the SU-8 polymer substrate required the use of complex, non-standard lithography in several steps. The realized substrate cannot be fabricated using polymer microinjection molding or using standard lithography. The design also features prominent voids and sharp angles which are susceptible to fouling the microfluidic system by air bubbles and microparticle sedimentation.

Simonnet 2005

Simonnet and co-workers (3) realized a microfluidic system 2D flow focusing microfluidic system that can be manufactured using standard fabrication techniques. The microfluidic system can focus the microparticles to a file as well as to a sheet. Thus, the microfluidic system allows for a high degree of control focused sample flow, since the height, thickness and width of the sample sheath flow can be controlled.

The microfluidic system is able to focus a sample dye with great precision. However, to demonstrate focusing of polystyrene beads additives, sucrose and dextran, were added to the sample liquid medium and the sheath liquid media. The purpose was to ensure that beads neutralized in buoyancy a severe restriction. The design holds many sharp angles and tight confinement of the channels leading to the susceptibility to fouling by sedimentation. Due to the complex interaction of laminar flow gradients and solid microparticles the performance achieved by focusing dyes cannot be expected to be reproduced with microparticles in the complex network of channels realized.

Although the microfluidic system can produce a 2D hydrodynamically focused flow this is specifically not achieved by 2D hydrodynamically focusing as with all the previously mentioned systems, but by cascading ID hydrodynamically focusing. Thus, the demonstrated microfluidic system does not present a new, extendable focusing principle or design but simply the combination of known technology.

The microfluidic system has 9 inlets requiring a total of 5 flow pumps, although only 7 inlets and 4 flow pumps are used in the paper, the remaining being inactive. Four or five flow pumps result in a considerable hardware expense and add to the complexity in terms of many fluidic interconnections and more electronics.

Wang 2005

An example of a microfluidic system for microparticle sorting (4) using 1D flow focusing. As a result the instrument containing the chip is designed with low NA (0.2) of the optical objective to allow long depth-of-focus to increase detection probability of the microparticles which are out of focus along the optical axis. As a mean for sorting, a laser beam was applied to displace the microparticles tangentially to the optical axis, thus in the substrate plane. Sorting speeds of 100 microparticles per second were demonstrated.

Chiu 2013

An example of a microfluidic system for microparticle 2D focusing has been demonstrated with only three inlets (two sheaths, one sample) (5). In the reference, the 2D focusing is called 3D focusing due to inconsistent use of terms in the field. They claim a microfluidic system capable of flow focusing comparable with commercial flow cytometers where the microparticles are in a file. Thus by reducing the coefficient of variation of velocity compared with a 1D focused microfluidic system they claim a lower risk of coincidental events in the photomultiplier detector. The microfluidic system achieves 2D focusing of the sample to a sheet rather than a file, but the formation of a sheet is an unintentional and unutilized artefact of the microfluidic system. In fact, the sheet is orientated such that the optical axis and substrate normal vector are both inside the sheet rather than oriented in a direction normal to it. The consequence of this is that there is an increased risk of coincidental events in the photomultiplier detector. The sheet is about 30 micron wide along the optical axis. They claim a microfluidic system comparable with commercial flow cytometers where the microparticles are in a file. Further the system is utilized only for fluorescence not for imaging. The work does present images from a CMOS camera with the optical axis orientated normal to the sheet but this is solely for the purpose of characterizing the focused flow, not imaging of microparticles. Additionally, it is carried out on a standard laboratory microscope (low NA—long working distance) not intended actual for measurements where a high NA objective would present an increased light collection efficiency as well as high optical resolution. It would not be possible to mount a high NA objective for optical inspection from the side due to the short working distances of high NA objective compared with the available minimal distance. For high quality microscope imaging the bonded interfaces of the substrates would intersect the optical light rendering high resolution diffraction limited impossible.

### SUMMARY OF THE INVENTION

### Introduction

Embodiments of the present invention provide a method and apparatus particularly suitable for sorting microparticles suspended in a fluid flowing in a channel of capillary size of a diameter of, e.g. less than 1 mm. As a sub-set of the method and apparatus mentioned is a method and apparatus for analyzing microparticles suspended in a fluid flowing in a channel of capillary size.

Preferred embodiments of the microfluidic system features 2D flow focusing of the microparticles in particularly adapted for analysis with high NA optical objectives and for laser sorting. Herein, microparticles are also referred to as microscopic objects.

In a first aspect, the invention provides a method for hydrodynamic focusing of a laminar and planar sample fluid flow in a system for analysis and/or sorting of microscopic objects in the sample fluid, wherein said system comprises an optical objective for optical inspection of the microscopic objects, the method comprising:
conveying the microscopic objects in the laminar flow of the sample fluid;
providing at least a first laminar and planar flow of a first sheath fluid and a second laminar and planar flow of a second sheath fluid;
hydrodynamically focusing the flow of the sample fluid at an optical inspection zone of the system by causing each of the first and second sheath flows to make planar contact with the flow of the sample fluid at two opposed planar flow surfaces of the sample fluid flow;
controlling the flow of the sample fluid and the first and second flows of the sheath fluids such that the sample fluid and the first and second sheath fluids flow in a common flow direction at the inspection zone of the system;
controlling said step of focusing the flow of the sample fluid in such a way that all of the microscopic objects in said sample fluid are caused to be conveyed in said flow direction in one single plane at the inspection zone of the system;
optically inspecting at least one of the microscopic objects in the fluid through said optical objective.

In a second aspect, the invention provides a hydrodynamic flow focusing device for optical analysis for analysis and/or sorting of microscopic objects in a sample fluid, the system comprising:
an optical inspection zone for optically inspecting the microscopic objects in the sample fluid flow;
an optical objective at the optical inspection zone;
a sample flow controller for controlling a laminar and planar flow of the sample fluid;
a sheath flow controller for controlling a laminar and planar flow of a first sheath fluid and a laminar and planar flow of a second sheath fluid;
a flow structure configured to hydrodynamically cause each of the first and second sheath flows to make planar contact with the flow of the sample fluid at two opposed planar flow surfaces of the sample fluid flow, so as to focus the flow of the sample fluid at said optical inspection zone;
wherein said flow structure is shaped and dimensioned such that of the microscopic objects in said sample fluid are conveyed in one single plane at the inspection zone of the system during used of the system.

In a third aspect the invention provides a method for selecting microscopic objects included in a laminar and planar sample fluid flow, said method comprising:
hydrodynamically focusing said sample fluid flow by means of a method according to the first aspect of the invention;
microscopically inspecting and analysing the microscopic objects in the sample fluid at the optical inspection zone;
selecting at least one microscopic object in the sample fluid on the basis of said microscopic analysis;
ejecting the at least one selected microscopic object out of the sample fluid flow by means of light or an electromagnetic beam;
subsequently splitting a combined flow of the flows of sheath fluids and the sample fluid into
   a selected flow including the at least one selected microscopic object, and
   a waste flow.

In a fourth aspect, the invention provides a system for selecting microscopic objects included in a laminar and planar sample fluid flow, said system comprising:
a hydrodynamic flow focusing device according to the third aspect of the invention;
means for microscopically inspecting and analysing the microscopic objects in the sample fluid at the optical inspection zone;
means for ejecting at least one selected microscopic object out of the sample fluid flow by means of light or an electromagnetic beam;
flow-separating means for splitting a combined flow of the flows of sheath fluids and the sample fluid into a selected flow including the at least one selected microscopic object and a waste flow.

As used in the present context, planar refers to a plane transverse to the optical axis as indicated, by way of example, in FIG. 5. Thus in preferred embodiments of the invention, hydrodynamically focusing the flow of the sample fluid at the optical inspection zone of the system is achieved by causing each of the first and second sheath flows to make contact along a planar interface with the flow of the sample fluid at two opposed planar flow surfaces of the sample fluid flow in a direction transverse, preferably perpendicular to the common flow direction. The sample fluid flow is thus sandwiched between the sheath flows, whereby interfaces between the sample fluid and each of the respective sheath flows form two parallel two-dimensional planes, between which the sample fluid flow is provided. At the inspection zone, the flow of the sample fluid is focused in such a way that all of the microscopic objects in said sample fluid are caused to be conveyed in the flow direction in one single plane at the inspection zone of the system, whereby the single plane lies between the sheath flows. At the inspection zone, a plurality of the microscopic objects may preferably be inspected simultaneously, as they may form or be located simultaneously along a straight line extending transverse, preferably perpendicularly, to the flow direction, i.e. preferably in the viewing direction of the optical objective.

In preferred embodiments of the invention, the sample inlet has a width less than the width of the sheath flow inlets. Preferably, the ratio between the width of the sheath flow inlets is at least 1.5 times, more preferably at least 2 times, such as at least 2.5 times, or even more preferably at least 3 times the width of the sample fluid inlet.

### General Summary of Analysis Function

In preferred embodiments, the microfluidic system enabled by the present invention focuses the sample flow hydrodynamically to a thin sheet, e.g. 5 micron in thickness, but with a larger width, e.g. 150 micron. The width of the sheet may cover the field of view of an optical system containing a microscope. The thin sheet may enable all microparticles to be in focus of the microscope when using high NA objectives (NA >0.2) with shallow depth of focus. High NA optical objectives enable detailed optical inspection of the microparticles, either with an electronic camera e.g. CCD or CMOS device, or an interrogating laser, e.g. of 488 nm wavelength, and a photomultiplier tube (PMT). The high NA facilitates both high optical resolution which is proportional to the NA and as well as high light collection efficiency which is proportional to NA squared, e.g. for fluorescence signal detection. Accordingly, multiple microscopic objects may be inspected simultaneously in the focus plane of a high NA optical objective.

### Description of Microfluidic Flow Cell

In laminar flow at low Reynolds numbers (<1000), the microparticles preferably follow the flow lines of the fluid medium.

The hydrodynamic flow focusing device according to the present invention is herein also referred to as a microfluidic flow cell. The chip may hold a sample inlet channel and two sheath flow channels which constitute the inlets to a cross junction. The three inlets in this cross junction are preferably arranged such they are rectangular in cross section and the single outlet to this cross junction is also rectangular. The fourth connection to this cross-junction may constitute an optical sorting chamber.

The sample inlet channel may be arranged with the two sheath flow channels on each side in the cross-junction. The function of the sheath inlets may be combined in a chamber such that the sample flow is reduced significantly in thickness by hydrodynamic focusing. One advantage of the existence of two sheath flow channels is that the sample flow may be optimally directed by the two sheath flows without geometrically confining the sample flow to a more narrow cross-section as would likely be the case with only one sheath flow. The sample inlet channel height may be 70 μm with a low tendency of clogging by larger microparticles and debris, but too large for microscopic inspection of the channels content of microparticles. The hydrodynamic focusing reduces the thickness of the sample flow to e.g. 5 μm such that it is suitable for optical inspection with a microscope, without the risk of clogging.

A special characteristic of the preferred embodiments of the invention is that the width of the sheath channels is larger than the width of the sample inlet channel. This implies that the sample flow is only hydrodynamically focused in a sheet in the center of the optical sorting chamber. A desirable trait is that a very low CV (coefficient of variation of velocity) of the microparticles is achievable. In the reverse situation, contrary to preferred embodiments of the present invention, the sample flow would extend to the sides of the optical sorting chamber. Since the flow velocity on the sides of a channel is zero (non-slip boundary condition), the microparticles close to the sides will have much lower flow velocity leading to a higher CV, which is well known within the field to increase variation of results.

Another desirable trait of the sample flow being narrower than the optical chamber is aiding the use of high NA microscope objectives (NA >0.2) enabling multiple microscopic objects to be inspected simultaneously. These require high NA and a broad light cone to achieved high resolution and contrast. Near the sides of the optical chamber the light cone is distorted, impairing optical quality, by the mismatching optical refractive indices across the material- fluid interface.

Of particular interest in this system is a simple network of channels that is robust to microparticle sedimentation and air bubble with a robustness resembling the larger systems.

### Sorting

In further aspects and embodiments of the invention, a new approach to optically sorting microparticles is presented.

Following the optical analysis, either image based or fluorescent based, the microfluidic flow cell may enable the microparticles to be sorted with a laser using the physical force of optical radiation pressure well known in the field of optical tweezers. Optical radiation pressure forces are possible on microparticles with an optical refractive index larger (or smaller) than their surrounding medium.

Specifically, the laser beam may be steerable in order to address a desired position in the sheet to exert a continuous, confined force on a microparticle moving in the fluid. The flow in the optical sorting chamber may reach a Y-branch leading into two outlets. The sample flow goes per default into the ‘waste’ outlet, whereas the laser exposed microparticles follows the flow into the ‘selected’ outlet.

Imaging methods can provide the position of the microparticle for the steerable laser, which may then address the microparticle at the exact time it passes and rapidly displace the microparticle in the moving fluid.

By appropriate management of the flow rate the laser exposed microparticles, which are displaced in the flow, e.g. 40 micron, go into the ‘selected’ outlet. All unexposed microparticles may go into the ‘waste’ outlet. It is thus preferable that the geometrical precision of the microfluidic system better than 40 micron to avoid accidental false positive and false negative sorted microparticles.

The microfluidic system consists of two or more substrates which may be machined using fabrication techniques which are well known to those skilled in the field. The substrates are assembled by bonding techniques to form the final microfluidic system. In an embodiment the chip is provided in four substrates which are stacked. The design of the individual substrates enables them to be produced using polymer microinjection molding which is well suited for mass production and which has very low marginal cost.

### Post Processing

At the ‘selected’ outlet the sorted microparticles may be retrieved or used in further processing on-chip. Possible analysis techniques are PCR, confocal microscopy, cultivation chambers, other on-chip functionality known to those skilled in total analysis microfluidic systems.

### Applications

The presented invention is particularly suited for analysing and sorting un-labelled whole blood in diagnostic applications. In this application whole blood with little or no pre-processing may be inserted into the microfluidic flow cell, Particular cells may be sorted on the basis of their morphology from the microscope images. The invention also has applications throughout cytology as well as sorting other microparticles. By using a laser for excitation of fluorescence the sorter may use a wide range of biomarkers in cytology. These biomarkers allow specific cells to be identified using fluorescent excitation incorporated in the invention.

### Further Embodiments of the Invention

Referring to the above recitation of the method, apparatus and system of the first, second, third and fourth aspects of the invention, further features of embodiments of the invention will now be described. The optical objective may be arranged to provide a view onto the sample fluid at the inspection zone in a viewing direction which is perpendicular to the common flow direction, and the planar flow of the sample fluid may have a height in said viewing direction, which is smaller than or equal to a depth of focus of the optical objective. Flows of the first and second sheaths fluids may form planar inlets to said inspection zone, each of said planar inlets being preferably wider in a direction perpendicular to the common flow direction than the width of the inspection zone when seen in the plane of each respective planar inlet. The sample fluid and the first and second sheath fluids may be conveyed at a common flow velocity in said common flow direction at the inspection zone. Respective flow rates of the sample fluid flow and the first and second sheath fluid flows may be controlled by applied pressure gradients in said flows. The flows may be three-dimensionally guided by at least three planar and mutually parallel substrate elements providing:
respective inlets, including said planar inlets formed by the sheath fluids, for said flows upstream of said inspection one,
at least one waste outlet downstream of the inspection, and
at least one further outlet for a selected flow downstream of the inspection zone.

The sheath fluids may have the same composition or different compositions. Thus, one sheath fluid may have the same composition as the other sheath fluid, or they may have different compositions.

A further step of splitting a combined flow of the flows of sheath fluids and the sample fluid into the selected flow and a waste flow downstream of the inspection zone may be provided. The step of splitting said combined flow may be carried out as the combined flow flows across a flow-separating edge extending parallel to said substrate elements and normal to the common flow direction.

In the hydrodynamic flow focusing device according to the present invention, at least one dimension of a flow channel for said flows is constant throughout a length of the inspection zone, said at least one dimension being transverse to a flow direction of said flows and extending in a viewing direction of the optical objective. The hydrodynamic flow focusing device may comprise at least three planar and mutually parallel substrate elements providing respective inlets for said flows upstream of said inspection zone, at least one waste outlet downstream of the inspection, and at least one selected outlet for a selected flow downstream of the inspection zone. The substrate elements may form opposed top and bottom walls and opposed side walls of the flow channel at said inspection zone, so as to provide a three-dimensional hydrodynamical focusing of the sample fluid flow. Respective ones of said substrate elements may define planar inlets to said inspection zone for the first and second sheath fluids, each of said planar inlets being wider in a direction perpendicular to the common flow direction than the width of the inspection zone when seen in the plane of each respective planar inlet. At least one of said substrate elements may define a planar inlet to the inspection zone for the sample fluid which is at most as wide as the width of the optical inspection zone in a direction perpendicular to the common flow direction when seen in the plane of the optical inspection zone. A flow separating means may be provided downstream of the inspection zone for splitting the combined flow of the sheath fluids and the sample fluid into a waste flow and the selected flow. The flow separating means may comprise a flow-separating edge extending parallel to said substrate elements and normal to a flow direction of said fluid flows. Embodiments of the device (microfluidic flow cell) for use in flow cytometry applications without laser manipulation of microscopic objects (or other selection thereof) may include a single outlet only.

In order to image a first part of a flow chamber, it may be possible to provide a light emitting device for illuminating the microscopic objects through an optical access. For example, the microscopic object may comprise fluorescent materials that may be induced by the light emitting device. The light emitting device may be a laser, in particular a laser in the visible or in the infrared domain, a laser diode, a fiber laser or a laser suitable for inducing fluorescence, for example a tunable laser.

Having optical access in the plane of the substrate plates may be advantageous in comparison to having optical access in a plane perpendicular to the substrate plates. By having optical access in the plane of the substrate plates, the optical access may be on a top of the substrate plate where there is possibility for a large optical access area, whereas by having optical access in a plane perpendicular to the substrate plates, the optical access may be on a side of the substrate plate where there is only possibility for a small optical access area. In particular, the use of high NA objectives typically require short working distances and thus a chip that is thin along the optical axis. Furthermore high optical material quality of the microfluidic flow cell is required not available with side view. Thus the present invention provides a large improvement compared with state-of-the art.

Accordingly, the present disclosure is providing a system for sorting microscopic objects comprising a hydrodynamic flow focusing device wherein the flow chamber comprises optical access in the plane of the substrate plates, imaging means having an optical axis normal to the optical access and configured to image the flow chamber, a light emitting device having incidence normal to the optical access and configured to target the flow chamber, and a sorting controller configured to analyse the output of the imaging means and control the light emitting device. One purpose of the present disclosure is to provide a design for a hydrodynamic flow device which may be manufactured in components, each belonging to a group known as 2.5D objects. 2.5D refers to a surface which is a projection of a plane into 3rd dimension—although the object is 3-dimensional, there are no overhanging elements possible. 2.5D objects are often preferred for machining. This implies that the design can be designed with common fabrication processes such as those used for glasses and polymers.

As described above, the disclosure is related to optical analysis of microscopic objects, but the present disclosure is also related to sorting of microscopic objects. In order for a sorting to take place it may be preferred to have two sheath flow outlet channels each in connection with two sheath flow outlets such that the microscopic objects can flow into either the one or the other sheath flow outlet channels and further into the one or the other sheath flow outlets, thereby being physically separated from each other, i.e. being sorted.

One purpose of having a light emitting device having incidence normal to the optical access and configured to target a second part of the flow chamber is to optically sort the cells, i.e. the role of the light emitting device is to sort the cells by an optical force.

In relation to the cell sorting, a further advantage of having a first and a second sheath flow inlet channel formed in separate substrate plates and each in connection with one of the sheath flow inlets may be that such configuration allows for an optical force to be normal to the substrate plates. In this way, the optical force may be able to optically displace microscopic objects, thereby sorting them.

Accordingly, it is a purpose of the present disclosure to provide a cost effective hydrodynamic flow device for optical analysis and sorting.

### BRIEF DESCRIPTION OF THE DRAWINGS

Embodiments and features of the invention will now be described with reference to the accompanying drawings wherein:

FIG. 1 illustrates the optical sorting chamber with the sample sheath flow providing optical access with an optical objective;

FIG. 2 illustrates the cross sections of sample and sheath flow inlet;

FIG. 3 shows the hydrodynamic compression of the sample flow creating the thin sample flow;

FIG. 4 illustrates the flow of sample and sheath fluids in an embodiment of the present invention;

FIG. 5 illustrates shows the flow of the microparticles through the field of view of the optical objective;

FIG. 6 a cross section illustrating the horizontal flow focusing along a streamline using the sheath flow;

FIG. 7 a cross section of an analysis system illustrating the flow of microparticles;

FIG. 8 a cross section of a sorting system illustrating the flow of microparticles;

FIGS. 9-11 shows a positive microparticle being catapulted to another streamline;

FIG. 12 illustrates an embodiment of the microfluidic flow cell comprising four substrates;

FIG. 13 a micrograph of an embodiment of the microfluidic flow cell;

FIG. 14 illustrates the flow of fluids through a hydrodynamic flow focusing device according to the present invention;

FIG. 15 illustrates the cross sectional flow through the optical sorting chamber;

FIGS. 16 and 17 illustrate the lumped circuits of the present invention; and

FIGS. 18 shows the coefficient of variation obtained with an embodiment of the present invention.

### DETAILED DESCRIPTION OF EMBODIMENTS OF THE INVENTION

### Terms

The term “microparticle” refers to small particles but not limited to the micrometer scale, <500 microns, and not limited to biological cells. The microparticle is preferably dielectric but can be metallic optically as well.

The term “substrate” as used herein refers to a piece of material with constant thickness preferably transparent and of optical quality but not limited to this. Preferably of glass, quartz, SU-8, Polycarbonate, Cyclic Olefin Copolymer (COC) polymers such as TOPAS®, polystyrene, Poly(methyl methacrylate) (PMMA). The substrate does not have to be hard, rigid sheet, but can be soft foil as well, such as Polydimethylsiloxane (PDMS) or other elastomeric material. The thickness of the substrate is typically 0.25 mm to 1 mm thick, but not limited to this thickness range.

The term “substrate plane” refers to a geometric plane which is parallel to the top or bottom of a substrate.

The term “substrate normal” refers to the direction of a vector having two 90 degrees angles to the substrate plane.

The term “pump” refers to an electronic controlled device capable of realizing a pressure driven fluidic flow in a tube of inside a structure

The term “flow controlled pump” refers to a pump where the output flow rate is the primary parameter, and the pressure may be a floating parameter. It is generally realized by displacing a piston or a peristaltic pump.

The term “pressure controlled pump” refers to a pump where the output pressure is the primary parameter, and the flow rate may be a floating parameter.

By ‘fluid channel’ is understood a pathway for fluid, such as tubing, such as a hollow channel in a solid element, such as a channel bounded by walls. The dimension of the fluid channel is typical of 100-1,000 μm wide, but not limited to this dimension. The depth of the fluid channel is typical 50-300 μm, but not limited to this dimension.

The term “microfluidic flow cell” as used herein refers to the flow cell providing the optical analysis or the optical sorting.

The term “optical sorting chamber” as used herein refers to a fluid channel in the microfluidic flow cell. The optical sorting chamber is connected to fluidic inlets and one or more outlets, as defined below. The optical sorting chamber is typically 600 μm wide, 350 μm high and 1 mm long, but not limited to these dimensions.

By ‘inlet’ is understood an entrance into the optical sorting chamber through which fluid may enter.

By ‘outlet’ is understood an exit from the optical sorting chamber, through which fluid may exit.

The term “sheath fluid” as used herein refers to a sheath of compatible liquid surrounding a microparticle for carrying one or more particles through a channel.

The term “top substrate” as used herein refers a plate of substrate located on the top part of the microfluidic flow cell and is the first substrate counting from top to bottom of the microfluidic flow cell.

The term “top middle substrate” as used herein refers a plate of substrate located just beneath the top substrate and is the second substrate counting from top to bottom of the microfluidic flow cell.

The term “bottom middle substrate” as used herein refers a plate of substrate located just beneath the top middle substrate and is the third substrate counting from top to bottom of the microfluidic flow cell.

The term “bottom substrate” as used herein refers a plate of substrate located just beneath the bottom middle substrate and is the fourth substrate counting from top to bottom of the microfluidic flow cell.

The term “microfluidic system”, as used herein refers to the microfluidic flow cell with the necessary auxiliary components for operating the flow through the chip will be referred to as the microfluidic system. The microfluidic system may include tubing, interconnects, tubing, valves, pumps, control electronics, sample injection loop, other microfluidic flowcells in connection with the chip, and additional on-chip functionality, known by the persons skilled in the art, such as filtering, PCR, on-chip staining by biomarkers.

The term “sample chamber” as used herein refers to a chamber of being typically, but not limited to, 2-5 μl in volume structured in the bottom middle substrate of the microfluidic flow cell. The chamber is connected to a sample inlet and externally to a pump.

The term “sample inlet” as used herein refers to an inlet into the optical sample chamber. The inlet introduces a fluid medium in which microparticles are suspended. The width at the exit of the sample inlet channel is typical of 125 μm, 250 μm, 500 μm, but not limited to these dimension. The depth at the exit of the sample inlet channel is typical of 70 μm, but not limited to this dimension.

The term “sheath flow inlet” as used herein refers to a channel to pinch the sample of microparticles into a thin layer of hydrodynamically focused sample flow. The width of the sheath flow inlet is typical of 500 μm, 750 μm, 1000 μm, but not limited to these dimensions. The height of the sheath flow inlet is typically 300 μm, but not limited to this dimension.

The term “waste flow channel” as used herein refers to one channel structured in the bottom substrate. The un-selected microparticles exit from the optical sorting chamber and enter into the waste flow channel.

The term “selected flow channel” as used herein refers to one channel structured in the top middle substrate. The selected microparticles exit from the optical sorting chamber and enter into the selected flow channel.

The term “microscope”, as used herein refers to any optical system compromising one or more optical objectives. The term is used in broader sense than to laboratory optical microscopes. Typically, microscopes may also compromise electronics devices for image acquisition, such as CCD and CMOS devices. They may also include lasers for excitation of fluorescence for imaging of cells.

The term “light emitting device” as used herein refers to a light source, in particular a laser in the visible or in the infrared domain, a laser diode, a fiber laser or a laser suitable for inducing fluorescence.

The invention presents an optical cell sorter relying on the usual sorting procedure:

1. Hydrodynamically focusing the fluid with microparticles in a thin file (or sheath layer).

2. Detection and analysis (Optical fluorescence, cell morphology etc.) for the basis of sorting.

3. Deflect cells of interest with an optical laser in flowing liquid medium (selected cells).

4. Two outlets which are asymmetrically biased such that each cell goes into the waste outlet if not deflected in step 3.

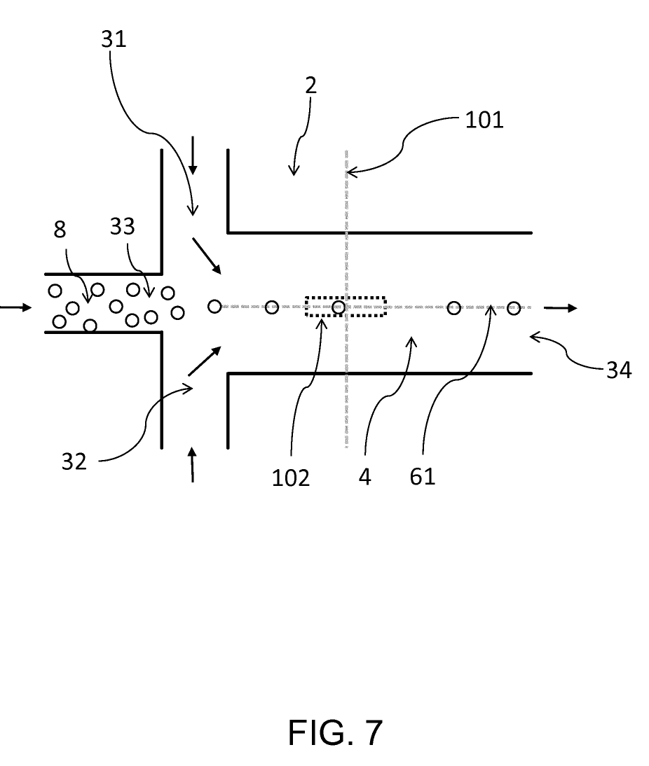

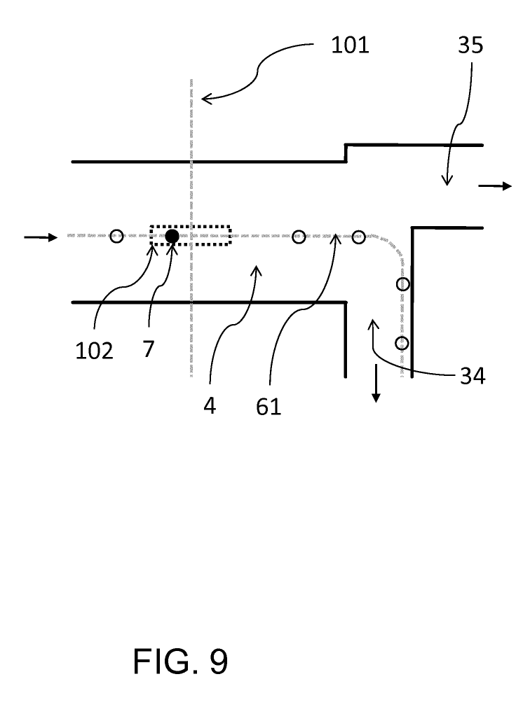

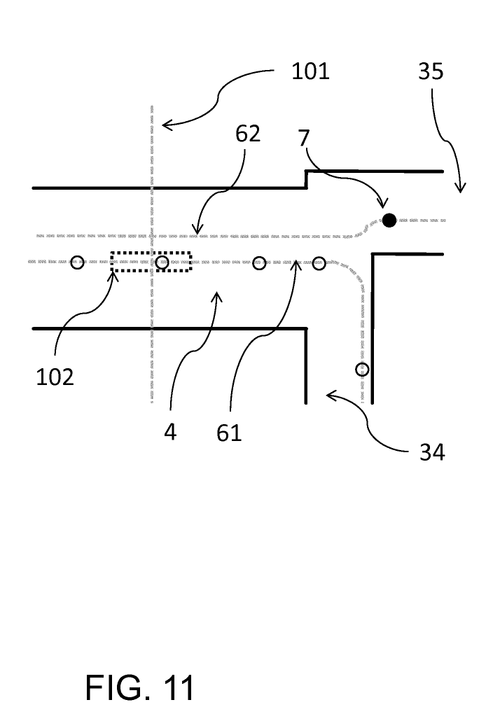

These steps are indicated in FIGS. 7-11.

### Detailed Description of Hydrodynamic Focusing

The invention presents a new approach to hydrodynamically focus the sample to thin sheath (sorting procedure step 1) which passes the field of view allowing detection and analysis (sorting procedure step 2), deflect microparticles based on selection (sorting procedure step 3), and separate the deflected microparticles by a Y-branch with two outlets (sorting procedure step 4).

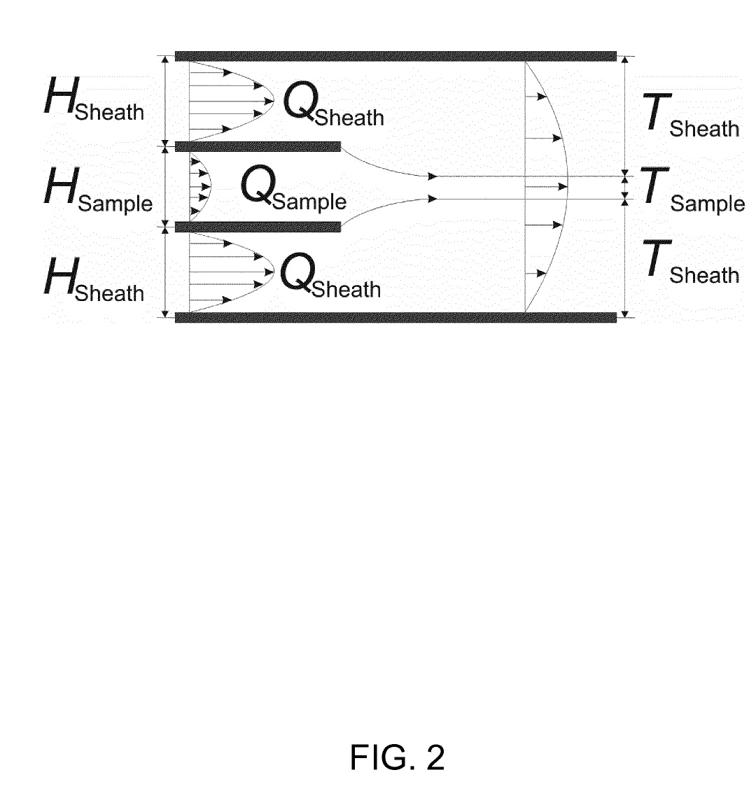

Hydrodynamic focusing is used to spatially focus a sample fluid to a thin layer. In FIG. 2 the principle is shown applied to a sample fluid in a sample inlet channel of height Hₛₐₘₚₗₑ by two opposing channels with sheath fluid of height Hₛₕₑₐₜₕ. The flow rates of the sheath fluid, Qₛₕₑₐₜₕ, is higher than the sample flow rate, Qₛₐₘₚₗₑ, causing the sample flow to be compressed to a smaller thickness, Hₛₐₘₚₗₑ<Tₛₐₘₚₗₑ according to the continuity equation of fluids. The flow is generally laminar with low Reynold's number (Re<1000) giving a non-turbulent, laminar flow. Microparticles suspended in the sheath fluid generally follow the streamlines of the flow, thus allowing the microparticles to be tightly focused. Obvious to the persons skilled in the art, the principle of hydrodynamic focusing can be extended to 3 dimensional structures to achieve 2 dimensional focusing, although such structures can be exceedingly difficult to fabricate due to their complexity. Also obvious is that due to the properties of laminar flow the orientation of the sheath flow inlets is of less importance since the flow is laminar. Thus the sheath flow inlets 31, 32 may equally well be oriented normal to the sample flow, and the hydrodynamic focusing will be similar.

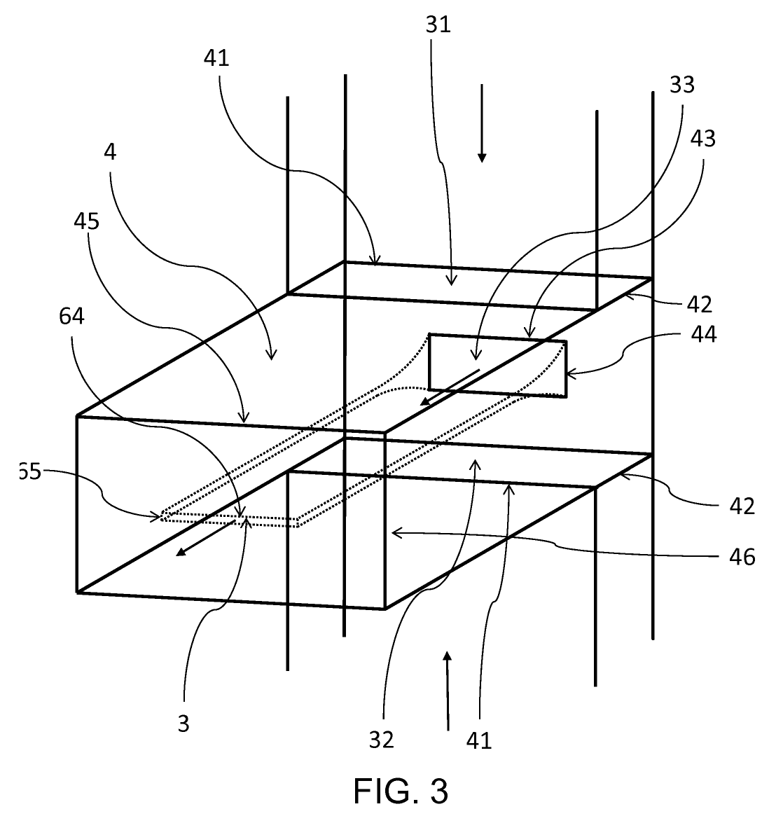

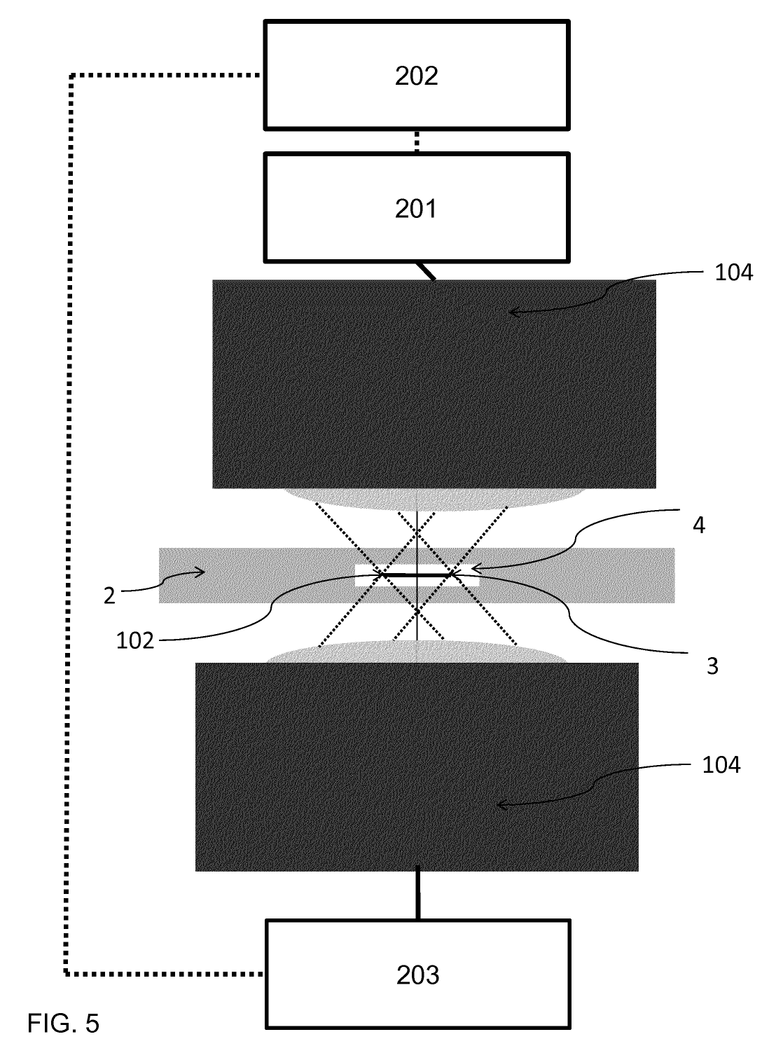

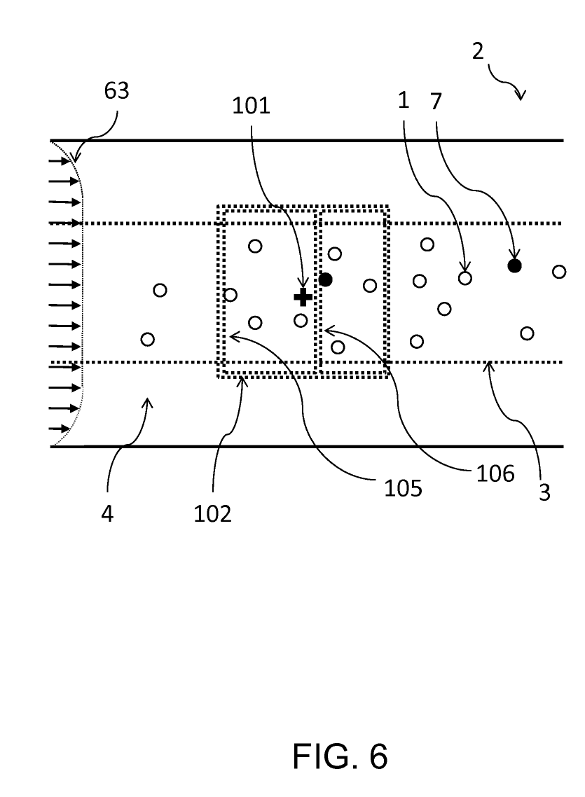

FIG. 3 shows the optical sorting chamber 4 with the connections of inlets 31, 32, 33 and outlets 34, 35. The sheath inlets 31, 32 are positioned at one end with a sample inlet 33 in between two opposing sheath inlets. The three inlets 31, 32, 33 focus the sample fluid in the sample inlet to a thin sheet with a width that is close to the width of the sample inlet 43. The sheath inlets 31, 32 have a width 41, which is wider than the sample inlet 43 and this is important in the formation of the sample sheet 3. The spatially thin sample sheath 3 forms a plane through the remainder of the optical sorting chamber 4 orthogonal to the optical axis 101 as seen in FIG. 5 and FIG. 6.

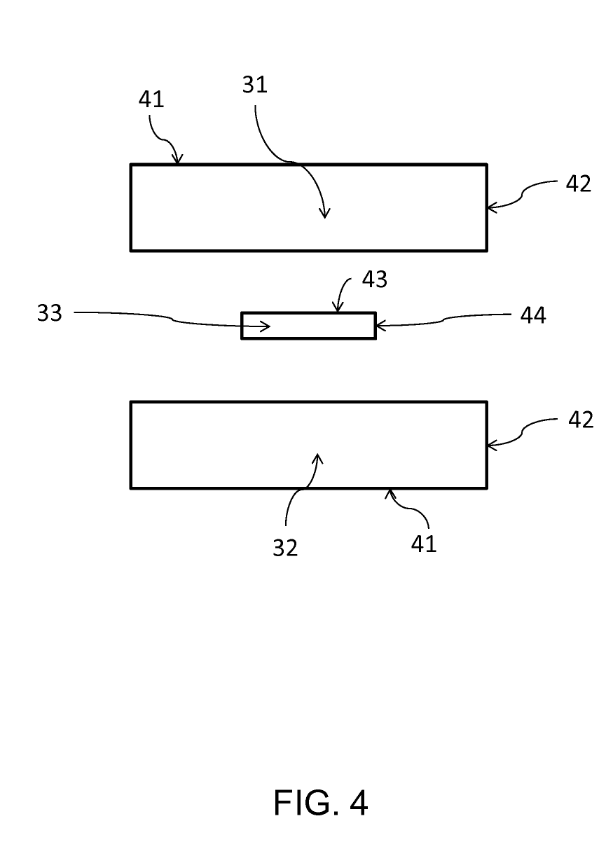

An embodiment of the three inlets 31, 32, 33 can be seen in FIG. 4 in scale.

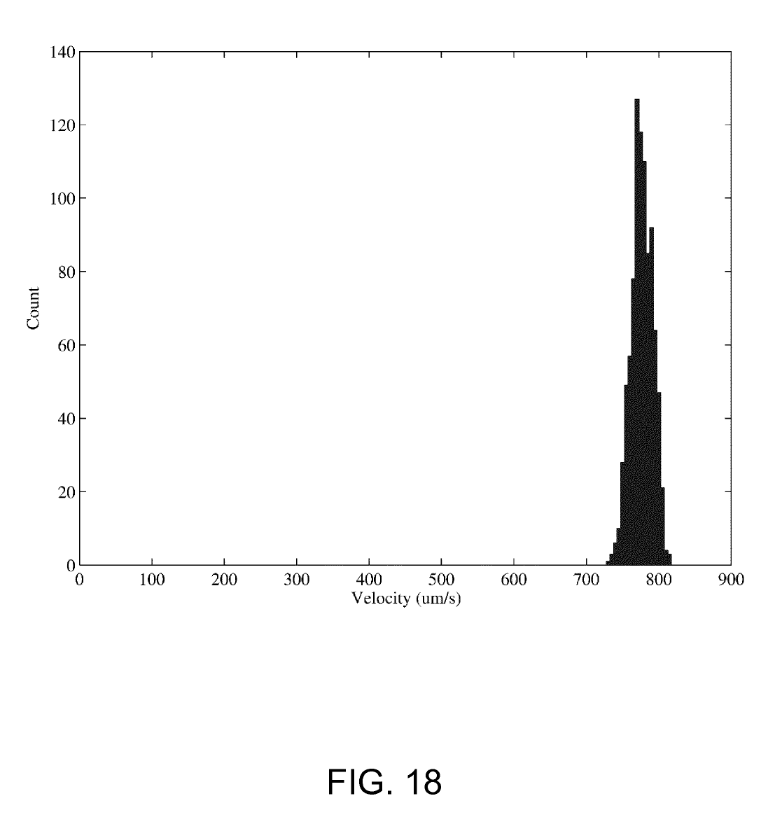

In one embodiment the CV was 1.9% in FIG. 18. The sheath flow rate was Qₛₕₑₐₜₕ=2.5 microL/min, the sample flow rate was Qₛₐₘₚₗₑ=0.025 microL/min. The sample was a suspension of 10 micron diameter polystyrene beads in distilled water. The sample was focused to sheath of approximately 150 micron width 64 with thickness approximately 12 micron 65.

On the other end of the optical sorting chamber there are two outlets, a ‘selected’ outlet 35 for one type of species and a ‘waste’ outlet 34 for the second type of species. In spite of the name, the ‘waste’ outlet can also output purified suspensions of microparticles 1.

At the outlet side the focused sample sheath 3 exits at the ‘waste’ outlet 34. The microparticles 1 which are to be selected exits at the selected outlet 35. The microparticles in the sample sheath layer 3 follows per default a streamline 61 with terminal in the waste outlet.

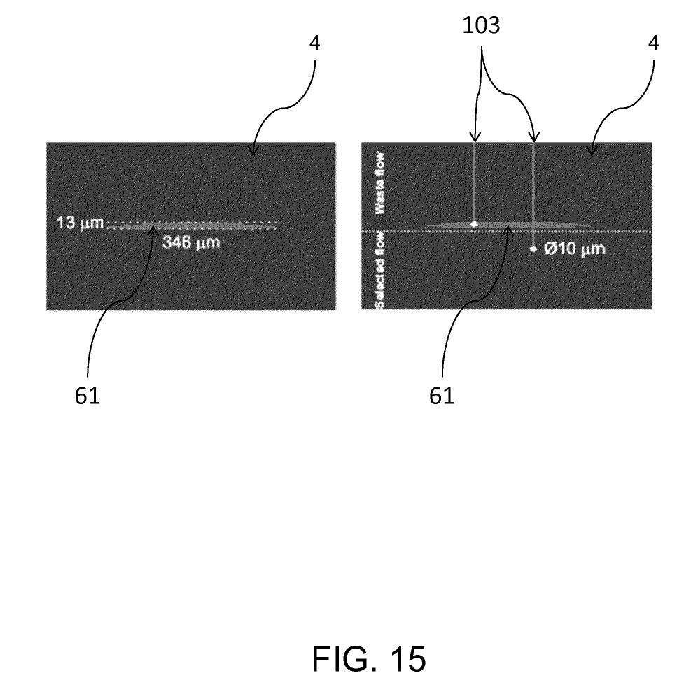

Using computational simulation tools such as computational fluid dynamics (CFD) the flow profile in complex geometries can be accurately predicted. FIG. 15 (left) shows a section though the optical sorting chamber 4 demonstrating the resulting sample sheath. The width of the optical sorting chamber 45 is 600 micron and the height 46 is 350 micron. The width of the sample inlet 43 is 300 micron and its height is 70 micron 44. The resulting sample sheath 3 is 346 microns wide 64 and 13 microns high 65. The flow is oriented in a direction normal to the section. CFD simulations show that the sample flow experiences a broadening of about 20% dependent on geometrical design and flow rates.

### Sheath Flow

In a preferred embodiment of the present disclosure, the device is configured such that two planar sheath flows are established parallel to each other within the flow chamber.

In another preferred embodiment of the present disclosure, the width of the planar sheath flows are less than 100 microns, less than 200 microns, less than 300 microns, less than 400 microns, less than 500 microns, less than 600 microns, less than 800 microns, less than 1000 microns.

According to the sample flow, and the relation with the sheath flow, the velocity profile of the planar sheath flows may be constant within 20%, within 15%, within 10% or within 5%.

In a preferred embodiment of the present disclosure, the thickness of each of the sheath flows is less than 500 micron, or less than 40 micron, or less than 30 micron, or less than 20 micron, or less than 15 micron, or less than 14 micron, or less than 13 micron, or less than 12 micron, or less than 11 micron, or less than 10 micron, or less than 9 micron, or less than 8 micron, or less than 7 micron, or less than 6 micron, or less than 5 micron, or less than 4 micron, or less than 3 micron, or less than 2 micron, or less than 1 micron.

In another preferred embodiment of the present disclosure, the microfluidic flow cell is configured such that a sample flow incident to the optical sorting chamber through the sample flow inlet 33 is hydrodynamically focused to one of the planar sheath flows by means of hydrodynamic flow compression. In this way there may be a natural flow of liquid, such that sorting may be configured for sorting microparticles 1 away from the natural flow following the streamline 61, such that the microparticles 1 may be guided into the other planar sheath flow following the streamline 62.

### Sheath Flow and Sample Flow Inlets

In a preferred embodiment of the present disclosure, the sheath flow inlets 31, 32 and the sample inlet 33 are formed in separate substrate plates. In this way, there may at least be three separate substrate plates.

In another preferred embodiment of the present disclosure, the top and bottom sheath flow inlets 31, 32 are arranged normal to the substrate plates. In this way, it may be possible to obtain sheath flow which connects to the sample flow inlet 33 in an identical manner such that the sheath flow from the sheath inlets 31, 32 may be close to being identical and thereby optimally configured. Another advantage of this configuration may be related to the ease of manufacture of the individual substrates, which are subsequently precision bonded.

In some embodiments of the present disclosure, one of the top 31 and bottom 32 sheath flow inlets are arranged normal to the substrate plates.

In some embodiments of the present disclosure, one of the top 31 and bottom 32 sheath flow inlets are arranged with an angle less than 90 degrees to the substrate plates preferably inclining such that the flow through sheath inlets 31, 32 experiences a change of direction less than 90 degrees.

In a preferred embodiment of the present disclosure, the width and/or height of the sheath flow inlet channels are less than 50 microns, less than 100 microns, less than 200, or less than 300 microns. In another preferred embodiment of the present disclosure, the width of the sheath flow inlets are less than 100 microns, less than 200 microns, less than 300 microns, less than 400 microns, less than 500 microns, less than 600 microns, less than 800 microns, less than 1000 microns.

In one embodiment of the present disclosure, the cross sectional area of the sheath flow inlets 31, 32 are identical, such that for example the pressure gradient across the top sheath flow inlet 31 and the sheath flow outlet(s) and over the bottom sheath flow inlet 32 and the sheath flow outlet(s) may be able to establish identical sheath flow in the flow chamber. The cross sectional area of the channels may be any suitable shape, in particular rectangular, elliptical or circular.

In a preferred embodiment of the present disclosure, the width of the optical sorting chamber is identical to the width of any of the sheath flow inlets 31, 32.

### Sheath Flow Outlets Channels and Sheath Flow Outlets

In another preferred embodiment of present disclosure, the sheath flow outlet channels are formed in separate substrate plates.

In a preferred embodiment of the present disclosure, the width and/or height of the sheath flow outlet channels are less than 50 microns, less than 100 microns, less than 200, or less than 300 microns. In another preferred embodiment of the present disclosure, the width of the sheath flow outlets are less than 100 microns, less than 200 microns, less than 300 microns, less than 400 microns, less than 500 microns, less than 600 microns, less than 800 microns, less than 1000 microns.

In a preferred embodiment of the present disclosure, the width of the optical sorting chamber is identical to the width of any of the sheath flow outlets 34, 35.

### Flow Chamber

In a preferred embodiment of the present disclosure, the length of the optical sorting chamber 4 is less than 0.5mm, less than 1 mm, less than 1.5 mm or less than 2.0 mm. The length of the optical sorting chamber 4 may be 0.5 mm, 1 mm, 1.5 mm or 2.0 mm.

In another preferred embodiment of the present disclosure, the width of the optical sorting chamber 4 is less than 0.3 mm, less than 0.6 mm, less than 0.9 mm or less than 1.2 mm. The width of the optical sorting chamber 4 may be 0.3 mm, 0.6 mm, 0.9 mm or 1.2 mm.

In yet another preferred embodiment of the present disclosure the height of the optical sorting chamber 4 is less than 0.1 mm, less than 0.2 mm, less than 0.3 mm or less than 0.4 mm. The height of the optical sorting chamber 4 may be 0.1 mm, 0.2 mm, 0.3 mm or 0.4 mm.

In a preferred embodiment of the present disclosure, the thickness of the sample flow is less than 50 micron, or less than 40 micron, or less than 30 micron, or less than 20 micron, or less than 15 micron, or less than 14 micron, or less than 13 micron, or less than 12 micron, or less than 11 micron, less than 10 microns, less than 9 microns, less than 8 microns, less than 7 microns, less than 6 microns, less than 5 microns, less than 4 microns, less than 3 microns, less than 2 microns or less than 1 micron. The sample flow may be between two sheath flows, in particular inside a flow chamber. Accordingly, the optical sorting chamber 4 and the sheath flows may be configured for establishing the sample sheath layer 3 flow as described above.

### Optics

One purpose of having the thickness 65 of the sample sheath layer 3 as described may be that microparticles 1 may then be in a well-defined plane, wherein optimal optical focus may be established, in particular from the imaging means of an optical objective 104 in connection with an optical detection system 201.

More preferably, the optical sorting chamber 4 may comprise optical access in the plane of the substrate plates. The optical access may be for optical analysis or optical analysis and optical sorting.

The microfluidic flow cell 4 has an aspect that is thin in the direction of the optical axis 101. This allows the use of objectives 104 with a short working length less than 1 mm, such as objectives with a magnification of 20×, 50×, and 100×. These objectives have a high NA for efficient light collection and high optical resolution and contrast. A high NA indicates that the optical objective 104 accepts a wide light cone from each point in the conveyor belt. Thus the aspect of the optical sorting chamber and the distance from the conveyor belt to the sides of the optical sorting chamber must be designed such that the light cone is not refracted from the sides giving a distorted image close to the sides of the channel.

In a preferred embodiment of the present disclosure, the distance from the sheath sample layer 3 to the side of the optical sorting chamber 4 is longer than half the height of the optical sorting chamber times the numerical aperture of the optical objective 23 divided by the refractive index of sheath buffer. The light cone of the objective may thus avoid interfering with the sides of the optical sorting chamber. The distance from the sheath sample layer 3 to the side of the optical sorting chamber 4 is obviously half the width optical sample chamber minus half the width of sample sheath layer.

In a preferred embodiment of the present disclosure, two objectives 104 may be used for light condenser and light collection. The condenser objective focuses the illuminating light onto the image plane, and the collection objective guides the light to the electronic imaging device 201 or human eye.

Optical Sorting with a Laser

Optical sorting may be of the microparticles 1 residing in the fluid that may flow in the microfluidic flow cell 2.

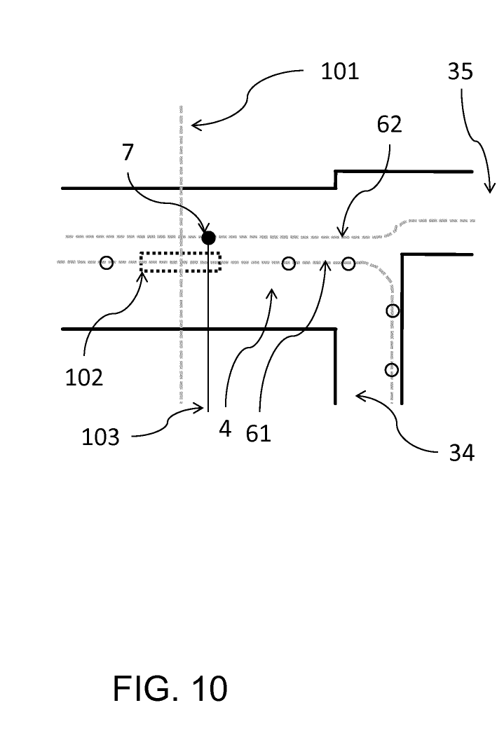

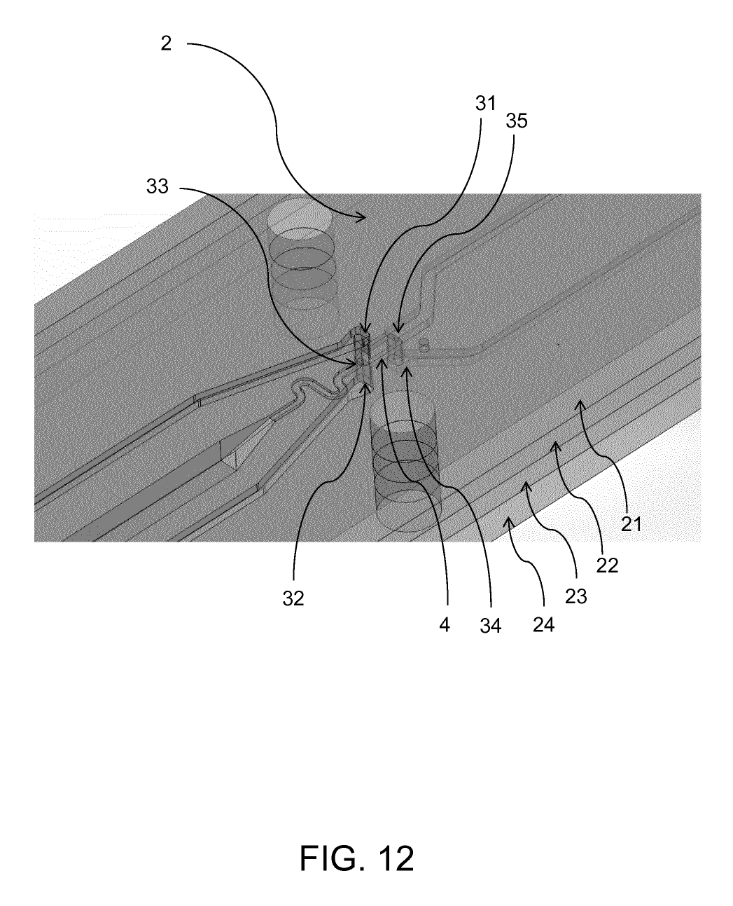

In a preferred embodiment, an optical laser beam 103 is configured to provide an optical force normal to the substrate plates as seen in FIG. 10 and FIG. 12. Accordingly, the optical force of the laser beam 103 may be in a direction normal to the substrate plates and adapted to displace a microscopic object suspended in a liquid medium in the flow chamber. The optical laser beam 103 may also be configured to yield optical forces in the plane with the substrate plates.

By displacing the microparticles 1 normal to the streamlines by the optical force, the microparticle may be to follow a streamline 62 with terminal in the selected outlet, thereby being optically and physically sorted.

According to the present disclosure, the sorting controller 202 may be configured to identify a plurality of predefined/pre-marked/specific microparticles in a liquid medium flowing in the optical sorting chamber 4. In this way, a selective sorting process may be obtained.

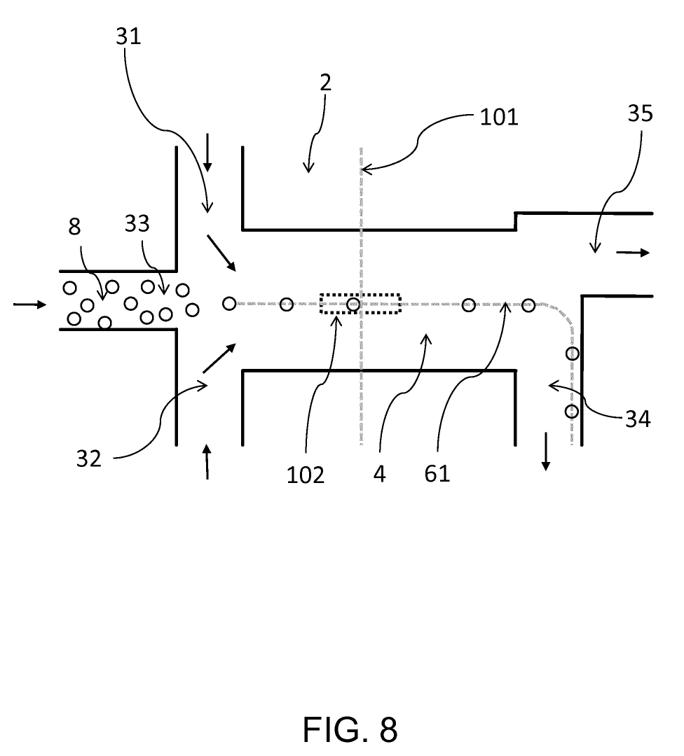

In a particular embodiment, an electronic imaging device is provided 201 as seen in FIG. 5. By image analysis the positions and preferably the velocity of the microparticle 1 can be found. A controller 202 can pass the detected position of microparticle to a system 203 that provides a laser beam 103 that coincides with position of the microparticle 1 such as to displace the microparticle by optical forces. The optical sorting is illustrated in FIGS. 8-11.

The optical force of the laser beam 103 in the plane with the substrate plates may be slowing down the microscopic objects. The decrease in microscopic object velocity may be an advantage in that it may allow for increasing the exposure time of the imaging means. A further advantage is that the exposure time to the manipulating laser beam 103 is increased. In this way, the decrease in microscopic object velocity may be used to increase the manipulation time of the force normal to the substrate plates.

In a particular embodiment, the microfluidic system provides optical access to the sample flow. A microscope consisting of least one optical objective 104 has a field of view and depth of focus which is in relation with the width 64 and the thickness 65 of the sample sheath layer. The microscope provides a light source for illuminating the sample sheath layer 3.

In a further embodiment the microscope has specifically one optical objective 104 that is used sample illumination and light collection.

In another embodiment the microscope has specifically two optical objectives 104, one optical objective 104 provides optical sample illumination and the other objective 104 provides light collection.

In a further embodiment the microfluidic system provides an outlet Y-branch and a pump connected to one of any outlet 34, 35 for separating the ‘selected’ microparticles and the ‘waste’ microparticles.

In a further embodiment the field of view 102 is divided into an analysis region 105 and a manipulation region 106 as seen in FIG. 6.

It is contemplated that the microscope can include one or more lasers for excitation of fluorescence and the necessary filters before the electronic imaging device.

It is contemplated that the microparticles may be used specific attachment of optically active labels, such as fluorescent labels of specific biomarkers known in the field of cytology.

### Flow Management

The embodiment also provides means for applying a pressure gradient in order to drive the sheath and sample fluid.

In a preferred embodiment of the present disclosure, the microfluidic flow cell is configured such that a pressure gradient can be applied over the top sheath, bottom sheath, and sample inlets 31, 32, 33 and the selected and waste outlets 35, 34.

The fluidic experiences a pressure drop along the channel, and the total pressure drop is proportional to the flow rate by a constant known as hydraulic resistance: ΔP=R_{hyd}Q. This is analogous to Ohm's law for electrical resistance, and the same circuitry schematics can be applied. ΔP, the pressure difference across the ends of the channel, corresponds to an electric voltage, Q., the flow rate, corresponds to electrical current.

Qₛₕₑₐₜₕ=Qₜₒₚ+Q_{bottom} is the sum of volumetric flow rate through the top, Qₜₒₚ, 31 and bottom sheath inlet Q_{bottom}, 32, Qₛₐₘₚₗₑ is the volumetric flow rate though the sample inlet 33, Q_{waste} is the volumetric flow rate through the waste outlet 34, and Q_{selected} is the volumetric flow rate through the selected outlet 35.

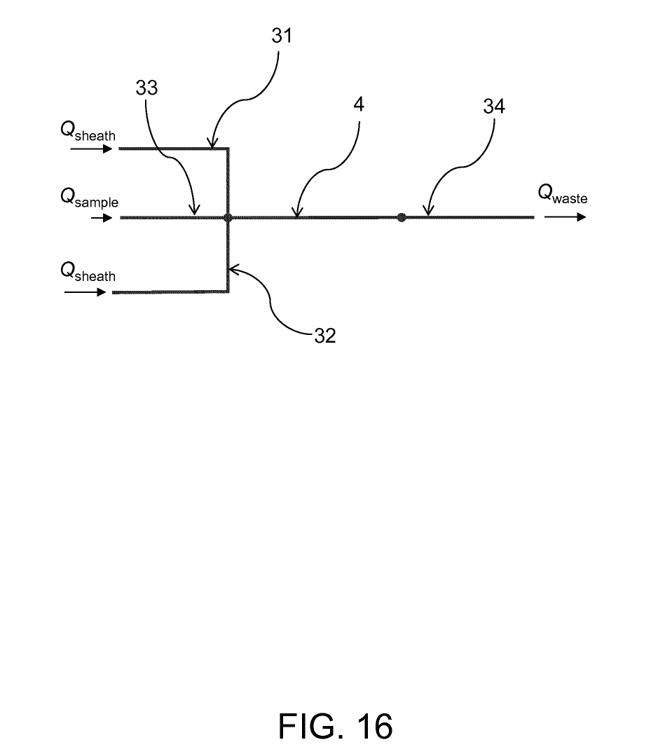

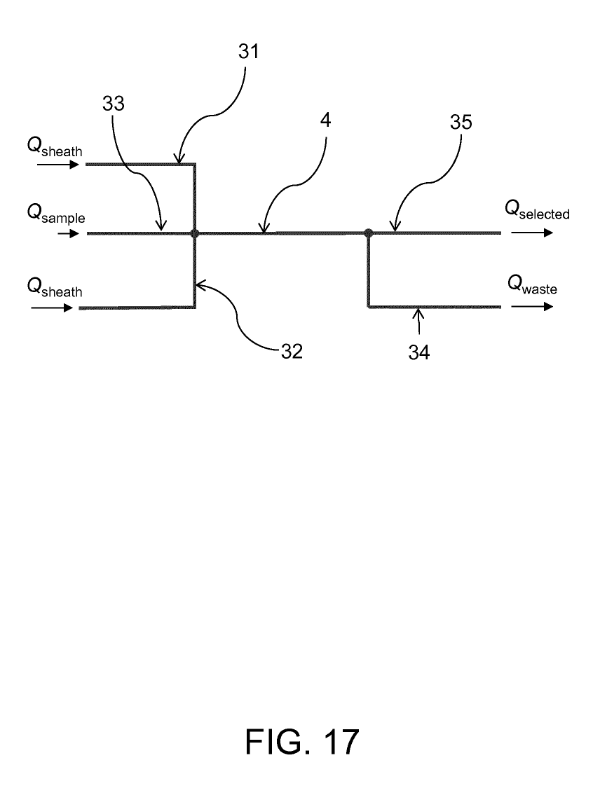

FIG. 16 shows the equivalent lumped circuit of the flow in the microfluidic flow cell for analysis and FIG. 17 shows the circuit for sorting. Using Kirchhoff's law on the lumped circuit we get the following equation for the flow

Qₛₐₘₚₗₑ+Qₜₒₚ+Q_{bottom}=Q_{waste}Q_{selected}

In order to focus the sample fluid the sample flow should be much lower than the sheath flow. Typical values are: Qₛₕₑₐₜₕ=0.1 microL/min, Qₛₕₑₐₜₕ=1 microL/min, Qₛₕₑₐₜₕ=10 microL/min, Qₛₕₑₐₜₕ=100 microL/min, Qₛₕₑₐₜₕ=1mL/min, and Qₛₐₘₚₗₑ<Qₛₕₑₐₜₕ/10, Qₛₐₘₚₗₑ<Qₛₕₑₐₜₕ/20, and Qₛₐₘₚₗₑ<Qₛₕₑₐₜₕ/30.

Accordingly, it may be very important that the pressure gradient is established as described and/or the inlets and/or outlets and/or channels are manufactured as described to allow for the herein described sample flow. Accordingly, the pressure gradient of the terminals of the channels connecting the inlets 31, 32, 33 and/or the outlets 34, 35 may be configured such that the velocity profile of the sample flow may be laminar and non-turbulent. In this way, the microparticles may be carried through the optical sorting chamber 4 with a velocity in relation to the flow and further move in a thin sample sheath layer 3. Typical velocity of microscopic objects may be 10 microns/s, 100 microns/s, 500 microns/s, 1000 microns/s, 2000 microns/s, or 5000 micron/s.

In an embodiment a flow bias can be configured to prevent microparticles 1 bound for the waste outlet 34 from entering into the selected outlet 35 given false positive or false negatives and vice versa for microparticles bound for the selected outlet 35 from entering the waste outlet 34. The flow rate at the waste outlet 34 is set to

Q_{waste}=Qₛₐₘₚₗₑ+Q_{bottom}+Q_{bias}

where Q_{bias} is a small parameter, such as Qₛₕₑₐₜₕ/100, Qₛₕₑₐₜₕ/50, Qₛₕₑₐₜₕ/25, Qₛₕₑₐₜₕ/10, that creates a retention distance such that a thin layer of sheath fluid is on top of the sample sheath layer 3 in the Y-junction of the outlets. The purpose being to avoid false positive microparticles entering the selected outlet 35. Q_{waste} is a flow rate that the waste pump draws liquid away from the microfluidic flow cell 2, as defined in FIG. 17. Since there is no pump connected to channel connecting the selected outlet 35, the flow rate through the selected outlet 35, Q_{selected} is determined by

Q_{selected}=Qₜₒₚ−Q_{bias}

Q_{selected} and thereby sorting purity are perturbed by any fluctuation in either Qₛₐₘₚₗₑ, Qₜₒₚ, Q_{bottom}, or Q_{waste}. A fluctuation may cause the selected streamline 62 to enter the waste outlet 34, or the waste streamline 61 to enter the selected outlet 35. In order to control the fluid flow in the microfluidic flow cell, only four of the five total inlets and outlets 31, 32, 33, 34, 35 need to have the flow rate actively controlled. The sheath flow rates, Qₜₒₚ, Q_{bottom} can be identical, Qₛₕₑₐₜₕ/2, for both two sheath inlets located on top and bottom 31, 32 in order to center the sample sheath layer 3 flow exactly in the optical sorting chamber. Only three flow rates are unique (Q_{waste}, Qₛₐₘₚₗₑ, Qₛₕₑₐₜₕ).

In an embodiment three pumps are used for sorting. One pump is used for controlling the flow rates Q_{waste}, Qₛₐₘₚₗₑ, and Qₛₕₑₐₜₕ.

In another embodiment, two pumps are connected to the sample inlet 33 and the sheath inlets 34, 35 used for optical analysis of the microparticles 1.

### Detailed Description of Fabrication of Microfluidic Flow Cell

Method for fabrication of microfluidic flow cell described here is not limited to construct the chip in one kind of material. The material of the microfluidic flow cell is preferably to be optically transparent, such as polymer, glass and elastomeric polymer.

For the substrates in polymer, milling, injection molding, hot embossing or femtosecond laser machining may be used to create the structures in each individual substrate. Thermal or other bonding methods such as ultrasonic welding or femtosecond laser welding can be used to form an embodiment of the microfluidic flow cell for mass production of the microfluidic flow cell or other techniques known to those skilled in the art.

A typical method for structuring of the glass substrates is by wet etching in the hydrofluoric acid (HF) based solution, or dry etching by using deep reactive-ion etching (DRIE) technology. The glass substrates are typically bonded by fusion bonding technique to form the microfluidic flow cell or other techniques known to those skilled in the art.

In a preferred embodiment of the present disclosure, the thickness of the substrate plates are less than 0.05 mm, less than 0.1 mm, less than 0.2 mm, less than 0.4 mm, less than 0.6 mm, less than 0.8 mm, less than 1.0 mm, less than 1.2 mm, less than 1.4 mm, less than 1.6 mm, less than 1.8 mm or less than 2 mm.

In a preferred embodiment of the present disclosure, he two or more bonded substrates are parallel to each other. In this way, it may be possible to connect structures from one substrate plate to another, thereby forming one complete microfluidic flow cell. The substrates are fabricated individually with structures such as fluid channels and optical sorting chambers in the substrate plane, and through-holes normal to the substrate plane. Once the substrates are bonded the grooves and structures may be closed to form a network of channels and chambers. In these channels it is possible to transport a medium by inducing a flow pressure on the open channel terminals. FIG. 12 shows schematically a stack of four substrates that may be bonded to form a microfluidic flow cell.

In some embodiments, the hydrodynamic flow focusing device is comprising four bonded parallel substrate plates, 21, 22, 23, 24, wherein four substrate plates are single sided, or wherein two substrate plates are double sided and two substrate plates are lids, or wherein two substrate plates are single sided, one substrate plate is double sided and one plate is a lid.

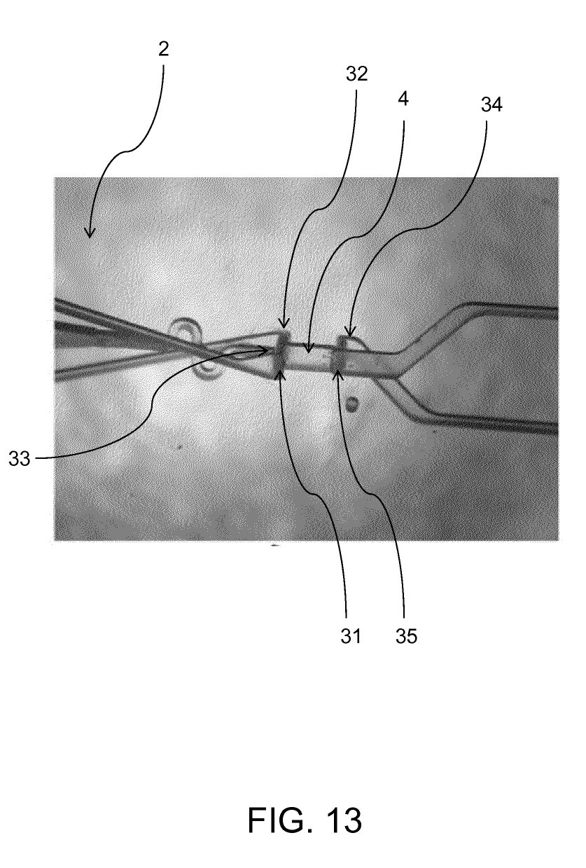

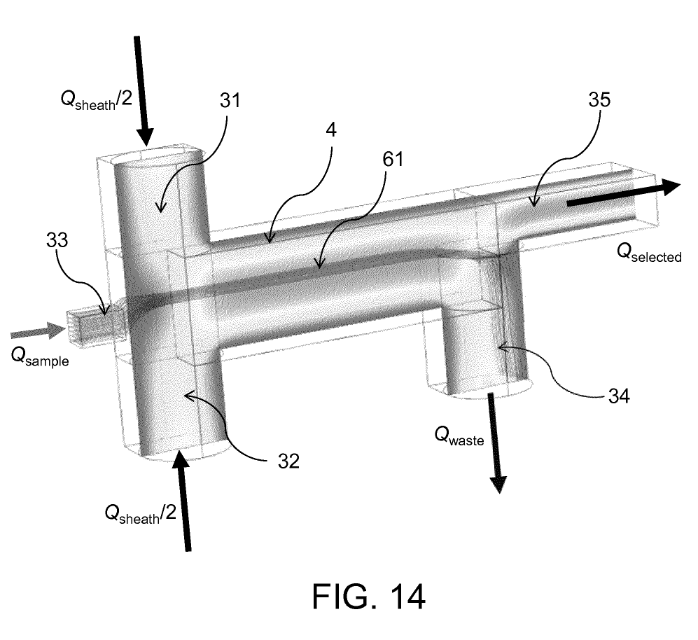

An embodiment of the invention can be seen in a micrograph in FIG. 4. From the left there are three inlet channels 31, 32, 33. The sample inlet 33 has a broader section in the far left that acts as a sample chamber. This part tapers to a channel which has a meandering part to disperse the suspended microparticles. The meander is not necessary for operating the invention. FIG. 13 shows another embodiment of a microfluidic flow cell according to the present invention. FIG. 7 and FIG. 8 show a side view of the hydrodynamic flow focusing device, and FIG. 14 is a perspective view of the microfluidic flow cell wherein the sample flow is shown as going from the sample flow inlet 33 and to the waste flow outlet 34. Referring to

FIG. 7 and FIG. 8, it can be seen that there is a top and a bottom sheath flow inlet, 31 and 32, respectively, and a waste and a selected outlet, 34 and 35, respectively. The sample flow is then hydrodynamically compressed to a sample sheath layer 3 which runs through the optical sorting chamber 4 with a cross section shown in FIG. 15. The optical sorting chamber 4 allows for both detection, analysis and deflection by a laser beam 103 of individual microparticles 1 in the sample sheath 3. This is seen in FIG. 7. The flow is then separated into the ‘waste’ and ‘selected’ outlets, 34 and 35. The arrangement of the outlets is such that the selected outlet 35 is a continuation of the optical sorting chamber 4, i.e. whereas the ‘waste’ outlet 34 is oriented at a 90 degrees angle with respect to the flow direction through the optical sorting chamber 4. This aspect of the embodiment is seen in FIG. 8. This embodiment is more robust to sedimentation of microparticles 1 which improves sorting purity, and is superior to a design where the selected outlet 34 and the waste outlet 35 both forms an angle of 90 degrees with respect to the flow direction through the optical sorting chamber 4 and are oriented normal to the substrate plane.

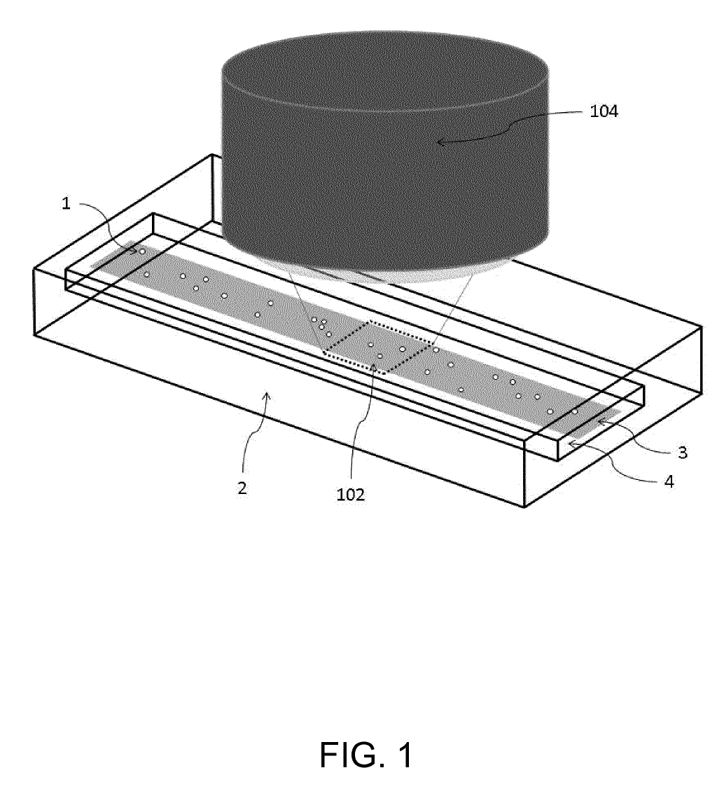

Referring to FIG. 1 and FIG. 8, show a possible schematic configuration of a system for sorting microparticles comprising a microfluidic flow cell wherein the optical sorting chamber comprises optical access in the plane of the substrate plates, imaging means having an optical axis 101 normal to the optical access and configured to image a first part of the optical sorting chamber 4, a laser beam 103 having incidence normal to the optical access and configured to target a second part of the optical sorting chamber 4.

1. A method for hydrodynamic focusing of a laminar and planar sample fluid flow in a system for analysis and/or sorting of microscopic objects in the sample fluid, wherein said system comprises an optical objective for optical inspection of the microscopic objects, the method comprising:
conveying the microscopic objects in the laminar flow of the sample fluid;
providing at least a first laminar and planar flow of a first sheath fluid and a second laminar and planar flow of a second sheath fluid;
hydrodynamically focusing the flow of the sample fluid at an optical inspection zone of the system by causing each of the first and second sheath flows to make planar contact with the flow of the sample fluid at two opposed planar flow surfaces of the sample fluid flow;
controlling the flow of the sample fluid and the first and second flows of the sheath fluids such that the sample fluid and the first and second sheath fluids flow in a common flow direction at the inspection zone of the system;
controlling said step of focusing the flow of the sample fluid in such a way that all of the microscopic objects in said sample fluid are caused to be conveyed in said flow direction in one single plane at the inspection zone of the system;
optically inspecting at least one of the microscopic objects in the fluid through said optical objective.

2. A method according to claim 1, wherein the optical objective defines a depth of focus and is arranged to provide a view onto the sample fluid at the inspection zone in a viewing direction which is perpendicular to the common flow direction, and wherein the planar flow of the sample fluid has a height in said viewing direction, which is smaller than or equal to the depth of focus of the optical objective.

3. A method according to claim 1, wherein flows of the first and second sheaths fluids form planar inlets to said inspection zone, each of said planar inlets being wider in a direction perpendicular to the common flow direction than the width of the inspection zone when seen in the plane of each respective planar inlet.

4. A method according to claim 1, wherein the sample fluid and the first and second sheath fluids are conveyed at a common flow velocity in said common flow direction at the inspection zone.

5. A method according to claim 1, wherein respective flow rates of the sample fluid flow and the first and second sheath fluid flows are controlled by applied pressure gradients in said flows.

6. A method according to claim 1, wherein said flows are three-dimensionally guided by at least three planar and mutually parallel substrate elements providing:
respective inlets, including said planar inlets formed by the sheath fluids, for said flows upstream of said inspection zone,
at least one waste outlet downstream of the inspection, and
at least one further outlet for a selected flow downstream of the inspection zone.

7. A method according to claim 6, comprising the step of splitting a combined flow of the flows of sheath fluids and the sample fluid into the selected flow and a waste flow downstream of the inspection zone.

8. A method according to claim 6, wherein the step of splitting said combined flow is carried out as the combined flow flows across a flow-separating edge extending parallel to said substrate elements and normal to the common flow direction.

9. A method for selecting microscopic objects included in a laminar and planar sample fluid flow, said method comprising:
hydrodynamically focusing said sample fluid flow by means of a method according to claim 1;
microscopically inspecting and analysing the microscopic objects in the sample fluid at the optical inspection zone;
selecting at least one microscopic object in the sample fluid on the basis of said microscopic analysis;
ejecting the at least one selected microscopic object out of the sample fluid flow by means of light or an electromagnetic beam;
subsequently splitting a combined flow of the flows of sheath fluids and the sample fluid into
a selected flow including the at least one selected microscopic object, and
a waste flow.

10. A hydrodynamic flow focusing device for optical analysis for analysis and/or sorting of microscopic objects in a sample fluid, the system comprising:
an optical inspection zone for optically inspecting the microscopic objects in the sample fluid flow;
an optical objective at the optical inspection zone;
a sample flow controller for controlling a laminar and planar flow of the sample fluid;
a sheath flow controller for controlling a laminar and planar flow of a first sheath fluid and a laminar and planar flow of a second sheath fluid;
a flow structure configured to hydrodynamically cause each of the first and second sheath flows to make planar contact with the flow of the sample fluid at two opposed planar flow surfaces of the sample fluid flow, so as to focus the flow of the sample fluid at said optical inspection zone;
wherein said flow structure is shaped and dimensioned such that the microscopic objects in said sample fluid are conveyed in one single plane at the inspection zone of the system during use of the system.

11. A hydrodynamic flow focusing device according to claim 10, wherein at least one dimension of a flow channel for said flows is constant throughout a length of the inspection zone, said at least one dimension being transverse to a flow direction of said flows and extending in a viewing direction of the optical objective.

12. A hydrodynamic flow focusing device according to claim 10, comprising at least three planar and mutually parallel substrate elements providing respective inlets for said flows upstream of said inspection zone, at least one waste outlet downstream of the inspection, and at least one selected outlet for a selected flow downstream of the inspection zone.

13. A hydrodynamic flow focusing device according to claim 10, comprising a flow separating means downstream of the inspection zone for splitting the combined flow of the sheath fluids and the sample fluid into a waste flow and the selected flow.

14. A hydrodynamic flow focusing device according to claim 13 wherein said flow separating means comprises a flow-separating edge extending parallel to said substrate elements and normal to a flow direction of said fluid flows.

15. A system for selecting microscopic objects included in a laminar and planar sample fluid flow, said system comprising:
a hydrodynamic flow focusing device according to claim 10;
means for microscopically inspecting and analysing the microscopic objects in the sample fluid at the optical inspection zone;
means for ejecting at least one selected microscopic object out of the sample fluid flow by means of light or an electromagnetic beam;
flow-separating means for splitting a combined flow of the flows of sheath fluids and the sample fluid into a selected flow including the at least one selected microscopic object and a waste flow.
